(19) United States
(12) Patent Application Publication
(10) Pub. No.: US 2025/0003687 A1
(43) Pub. Date: Jan. 2, 2025

(54) HEAT EXCHANGER

(71) Applicant: Conflux Technology Pty Ltd, Waurn Ponds (AU)

(72) Inventors: Gabrian BALELANG; Ashley DOWLE; Glenn REES; Michael FULLER

(21) Appl. No.: 18/710,114

(22) PCT Filed: Nov. 15, 2022
(86) PCT No.: PCT/AU22/51360

§ 371 Date: May 14, 2024

(30) Foreign Application Priority Data
Nov. 15, 2021 (AU) 2021903655

(51) Int. Cl. F28D 1/02; B33Y 80/00; F28D 7/10

(52) U.S. Cl. CPC F28D 1/02; F28D 7/106; B33Y 80/00; F28D 2001/026

(57) ABSTRACT

The present invention relates to a heat exchanger comprising: a core having a plurality of concentric channels extending along a central axis, the plurality of channels being concentric about the central axis and including: a first set of concentric channels through which a first fluid can pass; and a second set of concentric channels through which a second fluid can pass, to exchange heat with the first fluid passing through the first set of concentric channels, the concentric channels being alternatingly arranged, from the central axis, between a channel of the first set of concentric channels and a channel of the second set of concentric channels.

### FIELD OF THE INVENTION

The invention relates to a heat exchanger.

### BACKGROUND

Heat exchangers are used to transfer heat from one fluid to another. For example, a cooling system can utilise heat exchangers that transfer heat from working fluid to a coolant fluid. In high performance applications (such as in the automotive field), the overall mass and volume of the heat exchanger are significant factors as they impact fuel consumption, vehicle inertia and acceleration.

A heat exchanger that has a core with a relatively high heat transfer surface area to volume ratio can be referred to as a “compact heat exchanger”. A compact heat exchanger is typically assessed by a number of performance properties, including the inlet and outlet working fluid temperature difference, the working fluid flow rate through the exchanger, and inlet and outlet working fluid pressure difference. Heat exchangers in counterflow configuration provide high efficiency and are particularly useful when temperature difference between the hot and cold fluids is relatively small.

Manifolds or headers are needed to deliver hot and cold fluids into and out of the compact heat exchanger core. Manifolds can impact the performance of the heat exchanger core should it produce uneven fluid flow distribution through the core. Ideally, manifolds are also designed to induce minimum resistance to flow, therefore resulting in lower component pressure drop penalty.

Designing of manifolds for counterflow configuration to provide minimum pressure drop, compactness, and even flow distribution through the core is challenging. Conventionally manufactured manifolds can impede heat exchanger core performance due to uneven flow distribution. In addition, conventional manifolds are manufactured separately from the core and thus require joining and additional assembly to the core to form the complete heat exchanger. This tends to result in mechanical issues at the connection points between the manifold and the core.

In this context, there is a need for improved compact heat exchangers.

### SUMMARY

The present invention provides a heat exchanger comprising:
a core having a plurality of concentric channels extending along a central axis, the plurality of channels being concentric about the central axis and including:
   a first set of concentric channels through which a first fluid can pass; and
   a second set of concentric channels through which a second fluid can pass, to exchange heat with the first fluid passing through the first set of concentric channels,
the concentric channels being alternatingly arranged, from the central axis, between a channel of the first set of concentric channels and a channel of the second set of concentric channels.

Each channel of the plurality of concentric channels may be an elongate channel having a substantially annular cross-section.

The heat exchanger may further include a first inlet port for transporting the first fluid into the core and a first outlet port for transporting the first fluid from the core, wherein one or each of the first inlet port and first outlet port may define a manifold comprising a main channel (“first main channel”) that opens up into the first set of concentric channels of the core.

The first main channel may spread into a plurality of branches, and each branch may open up into a respective one of the concentric channels of the first set of concentric channels.

A spread of each branch from the first main channel may increase around the central axis to form a substantially concentric channel as the first main channel approaches the first set of concentric channels of the core.

The manifold walls defining each of said branches may be continuous and seamless with the walls defining the respective concentric channel of the first set of concentric channels to which the branch opens up.

The heat exchanger may further include a second inlet port for transporting the second fluid into the core and a second outlet port for transporting the second fluid from the core, wherein one or each of the second inlet port and second outlet port may define a manifold comprising a main channel (“second main channel”) that opens up into the second set of concentric channels of the core.

The second main channel may spread into a plurality of branches, and each branch may open up into a respective one of the concentric channels of the second set of concentric channels.

A spread of each branch from the second main channel may increase around the central axis to form a substantially concentric channel as the second main channel approaches the second set of concentric channels of the core.

The manifold walls defining each of said branches may be continuous and seamless with the walls defining the respective concentric channel of the second set of concentric channels to which the branch opens up.

Fluid flow through one or each of the first inlet port and the first outlet port may be along an axis that is substantially parallel to the central axis.

Fluid flow through one or each of the first inlet port and the first outlet port may be along an axis that is substantially orthogonal to the central axis.

Fluid flow through one or each of the second inlet port and the second outlet port may be along an axis that is substantially parallel to the central axis.

Fluid flow through one or each of the second inlet port and the second outlet port may be along an axis that is substantially orthogonal to the central axis.

The heat exchanger may further comprise one or more apertures in a manifold wall defining an outermost branch, wherein the or each aperture may be configured to provide a fluid pathway through said wall.

The heat exchanger may further comprise fins spanning adjacent manifold walls defining a branch.

The heat exchanger may be formed as a seamless unitary body via additive manufacturing.

### BRIEF DESCRIPTION OF THE DRAWINGS

The invention will now be described, by way of non-limiting example only, with reference to the accompanying drawings, in which:

FIG. 1A is a perspective view of a compact heat exchanger according to a first embodiment of the present invention;

FIG. 1B is an end view of the compact heat exchanger;

FIG. 1C is a cross-sectional view of the compact heat exchanger taken along line X-X of FIG. 1B, with hatching to illustrate the different fluid domains;

FIG. 1D is another cross-sectional view of the compact heat exchanger taken along line X-X of FIG. 1B, illustrating channels within the manifolds and core of the heat exchanger;

FIGS. 2A to 2I are cross-sectional views of the compact heat exchanger taken along lines A-A to I-I of FIG. 1C respectively;

FIG. 2J is a cutaway view of a portion of the compact heat exchanger to illustrate a first inlet manifold and a second outlet manifold according to one embodiment;

FIG. 2K is another cutaway view of a portion of the compact heat exchanger illustrating details of the first inlet manifold according to one embodiment;

FIG. 3A is a perspective view of a compact heat exchanger according to a second embodiment of the present invention;

FIG. 3B is an end view of the compact heat exchanger of FIG. 3A;

FIG. 3C is a cross-sectional view of the compact heat exchanger of FIG. 3A taken along line Y-Y of FIG. 3B, with hatching to illustrate the different fluid domains;

FIG. 3D is another cross-sectional view of the compact heat exchanger of FIG. 3A taken along line Y-Y of FIG. 3B, illustrating channels within the manifolds and core of the heat exchanger;

FIGS. 4A to 4G are cross-sectional views of the compact heat exchanger of FIG. 3A taken along lines A-A to G-G of FIG. 3C respectively;

FIG. 4H is a cutaway view of a portion of the compact heat exchanger to illustrate a first inlet manifold and a second outlet manifold according to a second embodiment;

FIG. 5A is a perspective view of a compact heat exchanger according to a third embodiment of the present invention;

FIG. 5B is an end view of the compact heat exchanger of FIG. 5A;

FIG. 5C is a cross-sectional view of the compact heat exchanger of FIG. 5A taken along line Z-Z of FIG. 5B, with hatching to illustrate the different fluid domains;

FIGS. 6A to 6G are cross-sectional views of the compact heat exchanger of FIG. 5A taken along lines A-A to G-G of FIG. 5C respectively; and

FIG. 7 includes a close up view of a manifold.

### DETAILED DESCRIPTION

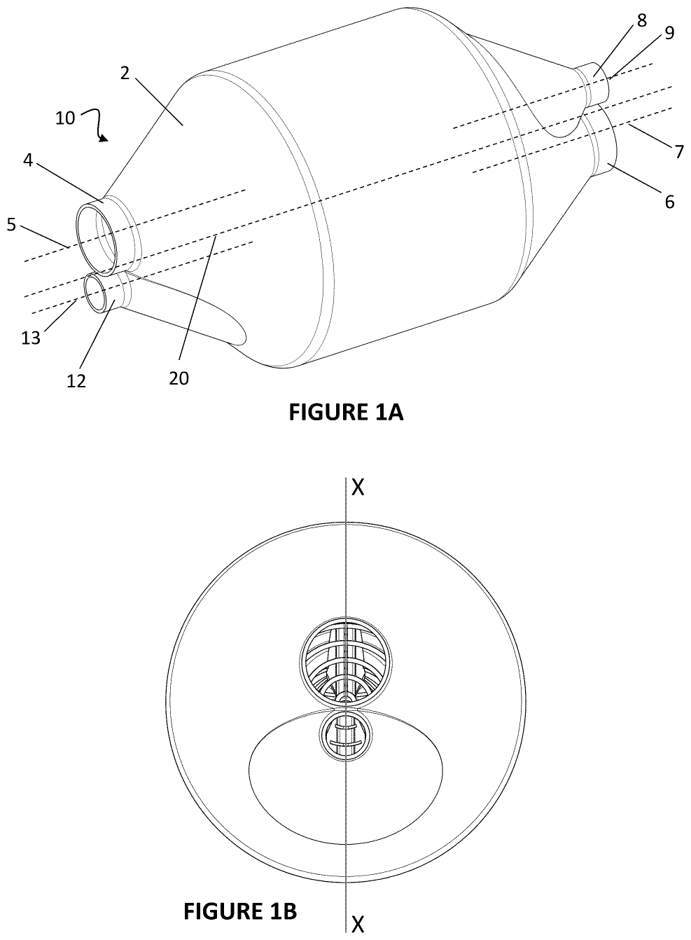

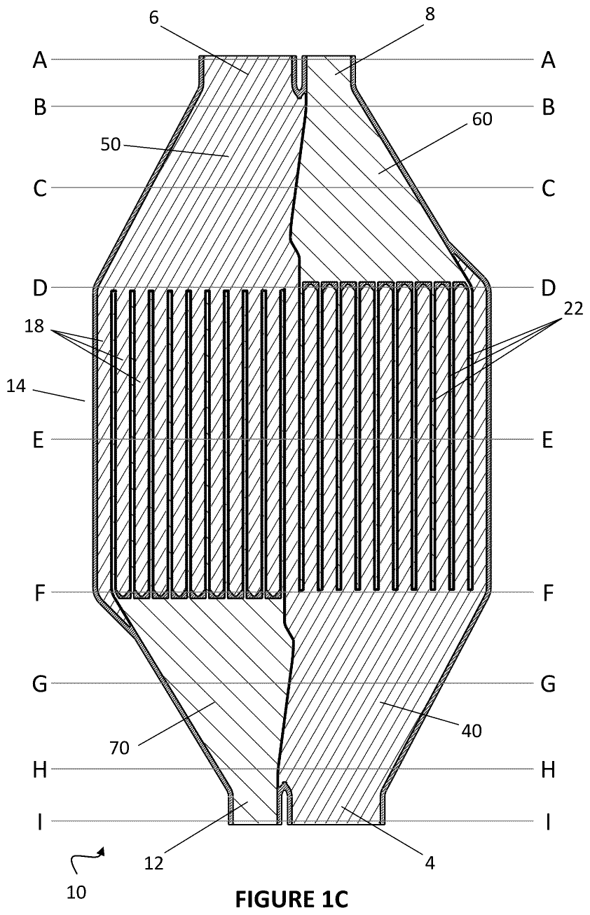

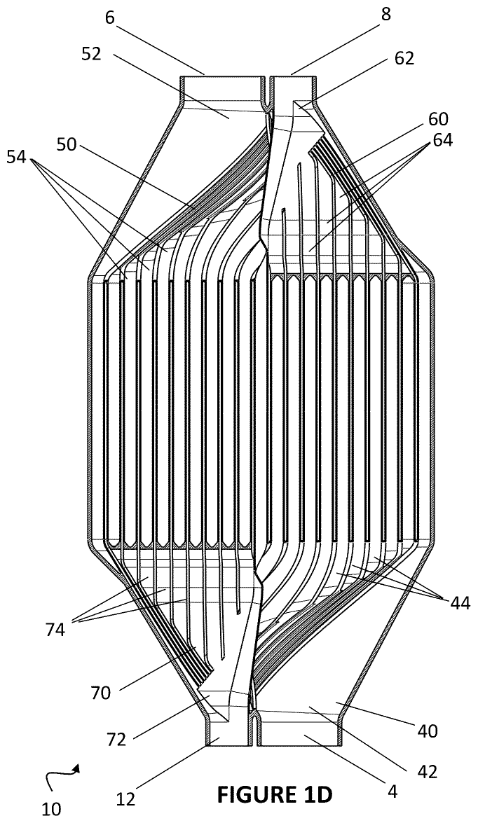

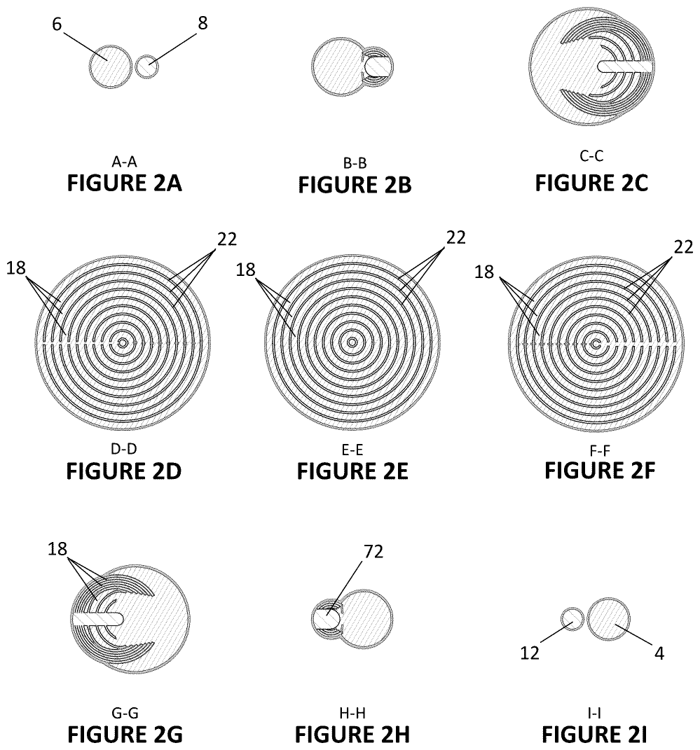

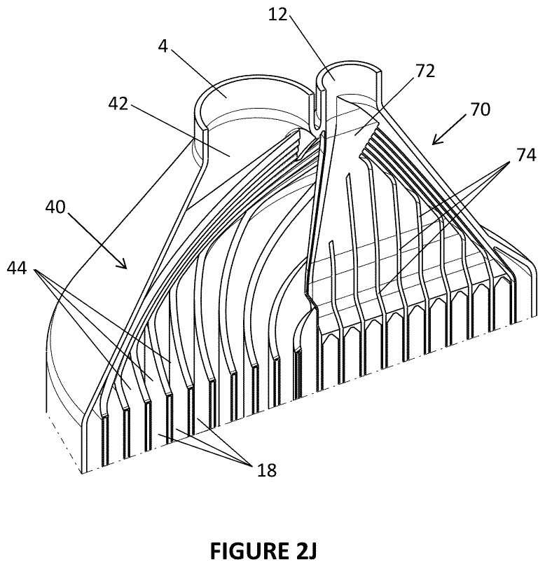

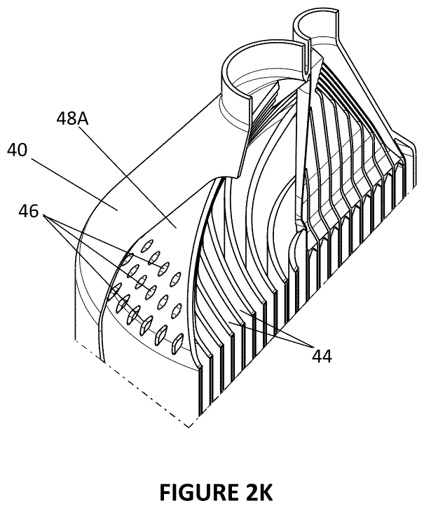

FIGS. 1A to 2K illustrate a heat exchanger 10 according to one embodiment of the present invention. The heat exchanger has an outer shell 2 defining a first inlet port 4, a first outlet port 6, a second inlet port 8 and a second outlet port 12.

Within the heat exchanger 10 is a core 14 comprising a plurality of concentric channels extending along a central axis 20. The plurality of channels are concentric about the central axis 20, and include a first set of concentric channels 18 and a second set of concentric channels 22. For clarity and succinctness, only a few of the channels of each of the first and second set 18, 22 have been labelled in the drawings.

In use, a first fluid enters the heat exchanger 10 via the first inlet port 4, passes through the core 14 via the first set of concentric channels 18 and exits the heat exchanger 10 via the first outlet port 6. A second fluid enters the heat exchanger 10 via the second inlet port 8, passes through the core 14 via the second set of concentric channels 22 and exits the heat exchanger 10 via the second outlet port 12.

As the first and second fluids flow through the heat exchanger 10, thermal energy is transferred between the two fluids. As shown more clearly in FIGS. 1C and 2D to 2F, the concentric channels are alternatingly arranged, from the central axis, between a channel of the first set of concentric channels 18 and a channel of the second set of concentric channels 22. Each set of concentric channels 18, 22 comprises a plurality of channels. That is, the first set 18 preferably comprises more than two concentric channels for receiving the first fluid, and the second set 22 preferably comprises more than two concentric channels for receiving the second fluid.

Each channel is an elongate channel extending along the direction of the central axis 20. Each channel has a substantially annular cross-section, although, in some regions, optional radially-extending fins (not shown) may intersect the channels.

The heat exchanger 10 comprises a first inlet manifold 40, contained within the outer shell 2, which is in fluid communication with the first inlet port 4 and the first set of concentric channels 18. Specifically, the first inlet manifold 40 connects the first inlet port 4 to the first set of concentric channels 18 and is configured to facilitate even flow distribution of the first fluid into each channel of the first set of concentric channels 18. FIG. 2J is a close up view illustrating one example embodiment of the first inlet manifold 40. The first inlet manifold 40 comprises a first main channel 42 that spreads into a plurality of first branches 44 as the first main channel 42 opens up into the first set of concentric channels 18. Each of the first branches 44 is in fluid communication with a respective one of the channels of the first set of concentric channels 18.

In the example illustrated in FIGS. 1A to 2K, the inlet and outlet ends of the heat exchanger 10 are substantially identical. Accordingly, the heat exchanger 10 comprises a first outlet manifold 50, which is structurally substantially identical to the first inlet manifold 40, in that it comprises a first main channel 52, defined in the first outlet port 6, that spreads into a plurality of first branches 54, each branch being in fluid communication with one of the channels of the first set of concentric channels 18. In other examples, the first inlet manifold 40 may be different from the first outlet manifold 50.

Preferably, the first branches 44, 54 open up seamlessly into the first set of concentric channels 18, i.e. there are no seams at the connection between the walls of the first branches 44, 54 and the walls of the first set of concentric channels. The spread (in cross-sectional area) of each branch 44, 54 from the first main channel 42, 52 increases around the central axis to form a substantially concentric channel as the first main channel approaches the first set of concentric channels 18 of the core. In the illustrated examples, the first branches 44, 54 are arranged to spread from the first main channel 42, 52 to the first set of concentric channels 18 in a spiral configuration.

The heat exchanger 10 similarly comprises a second inlet manifold 60 and a second outlet manifold 70, contained within the outer shell 2. Specifically, the second inlet manifold 60 connects the second inlet port 8 to the second set of concentric channels 22 and is configured to facilitate even flow distribution of the second fluid into each channel of the second set of concentric channels 22. The second inlet manifold 60 comprises a second main channel 62 that spreads into a plurality of second branches 64 as the second main channel 62 opens up into the second set of concentric channels 22.

In one embodiment, the second inlet manifold 60 and the second outlet manifold 70 are structurally substantially identical. In other examples, the second inlet manifold 60 may be different from the second outlet manifold 70.

The second outlet manifold 70 connects the second set of concentric channels 22 with the second outlet port 12, and comprises a second main channel 72 that spreads into a plurality of second branches 74 as the second main channel 72 opens up into the second set of concentric channels 22. Each of the second branches 74 is in fluid communication with a respective one of the channels of the second set of concentric channels 22.

Preferably, the second branches 64, 74 open up seamlessly into the second set of concentric channels 22, i.e. there are no seams at the connection between the walls of the second branches 64, 74 and the walls of the second set of concentric channels. The spread (in cross-sectional area) of each branch 64, 74 from the second main channel 62, 72 increases around the central axis to form a substantially concentric channel as the second main channel approaches the second set of concentric channels 22 of the core.

FIG. 2K shows in more detail the manifold walls 48 defining the first branches 44 within first inlet manifold 40 according to one embodiment. Apertures 46 in first manifold wall 48A (the wall defining the outermost branch) provide flow pathways from the main channel 42 to the first branches 44, to facilitate fluid flow into the first branches 44. Each of the first outlet manifold 50, second inlet manifold 60 and second outlet manifold 70 may comprise a similar (or identical) aperture arrangement on an outermost manifold wall.

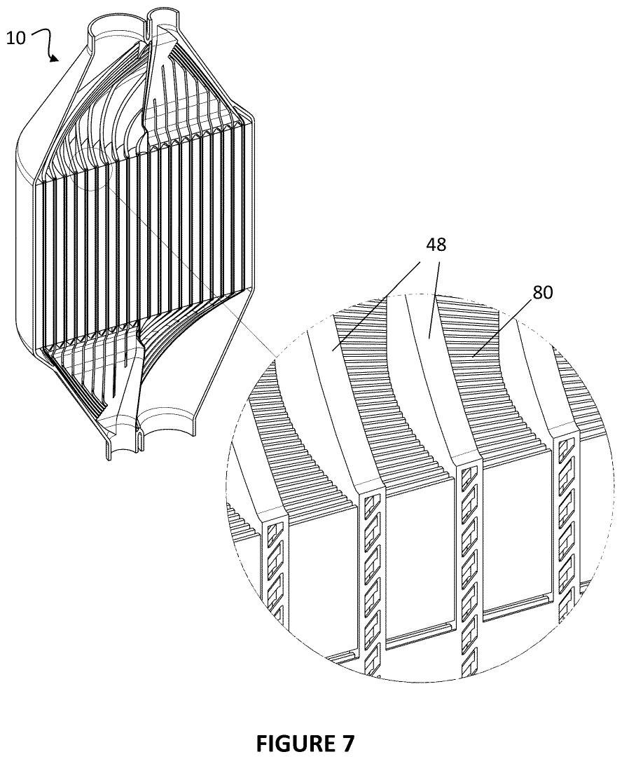

The manifold 40 may comprise fins 80 spanning the walls of the branches, such as shown in FIG. 7, to improve the heat exchange efficiency of the device. Particularly, the manifold of preferred embodiments enables counterflow heat exchange to be utilised in applications where crossflow heat exchange was typically the only method available. Counterflow heat exchange is generally preferred over crossflow due to improved efficiencies. Further, fins 80 improve the structural integrity of the manifold.

In the embodiment illustrated in in FIGS. 1A to 2K, the first fluid flows through the first inlet port 4 along a first axis 5 that is substantially parallel to the central axis 20, and through the first outlet port 6 along a second axis 7 that is also substantially parallel to the central axis 20. Similarly, the second fluid flows through the second inlet port 8 along a third axis 9 that is substantially parallel to the central axis 20, and through the second outlet port 12 along a fourth axis 13 that is also substantially parallel to the central axis 20.

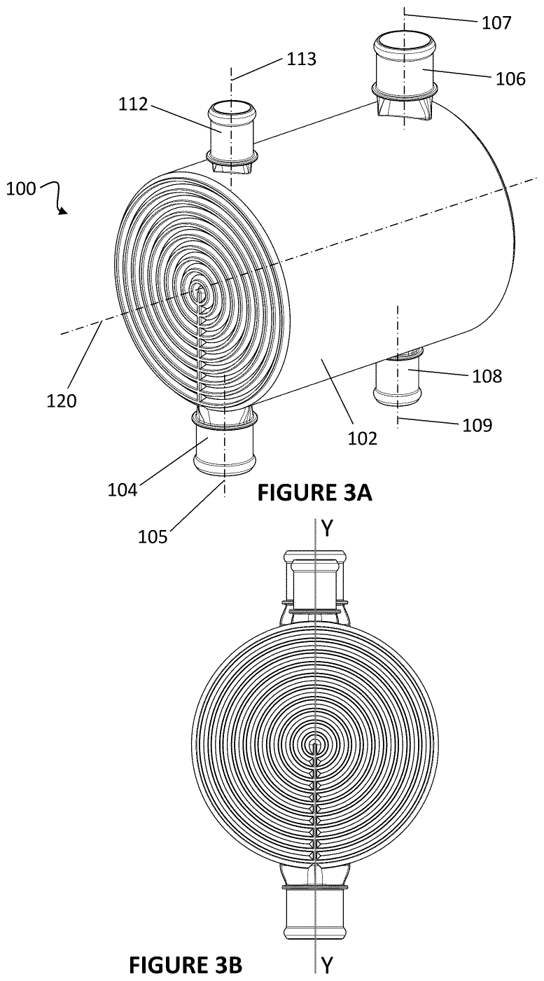

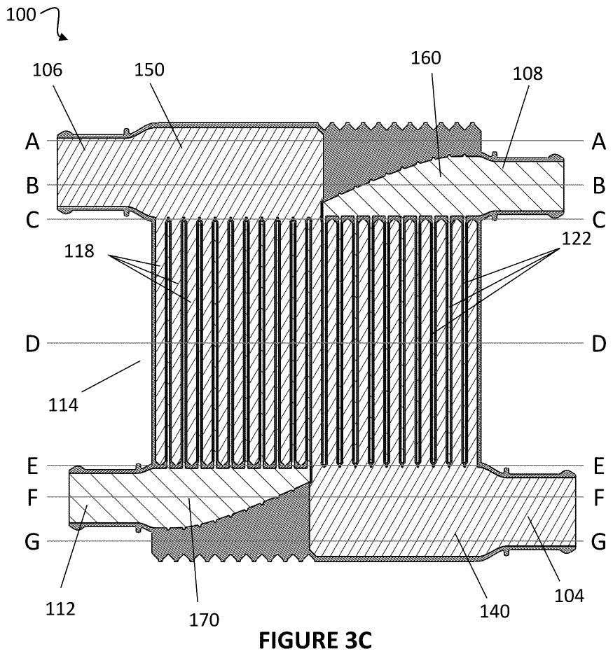

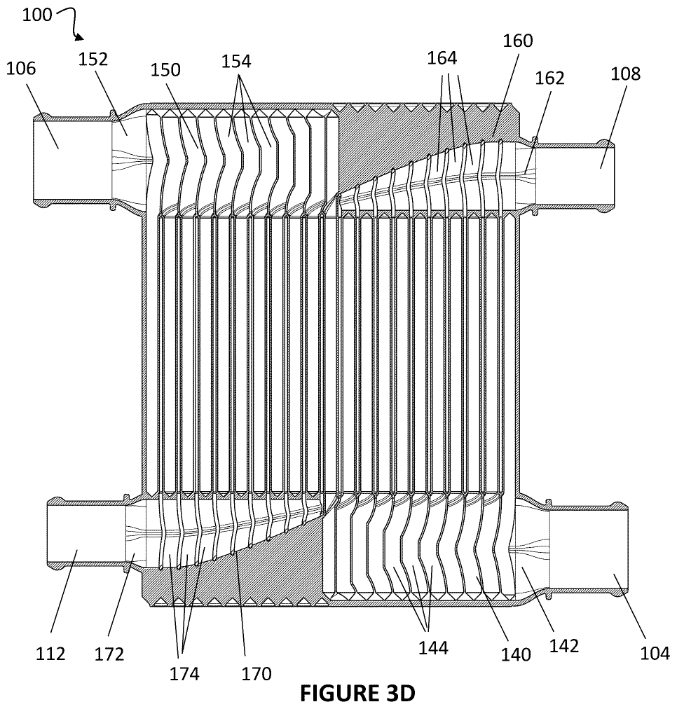

In other embodiments, such as those illustrated in FIGS. 3A to 4H and FIGS. 5A to 6G, flow through the inlet ports 104, 108, 204, 208 and the outlet ports 106, 112, 206, 212 extend along axes which are substantially orthogonal to the central axis 20.

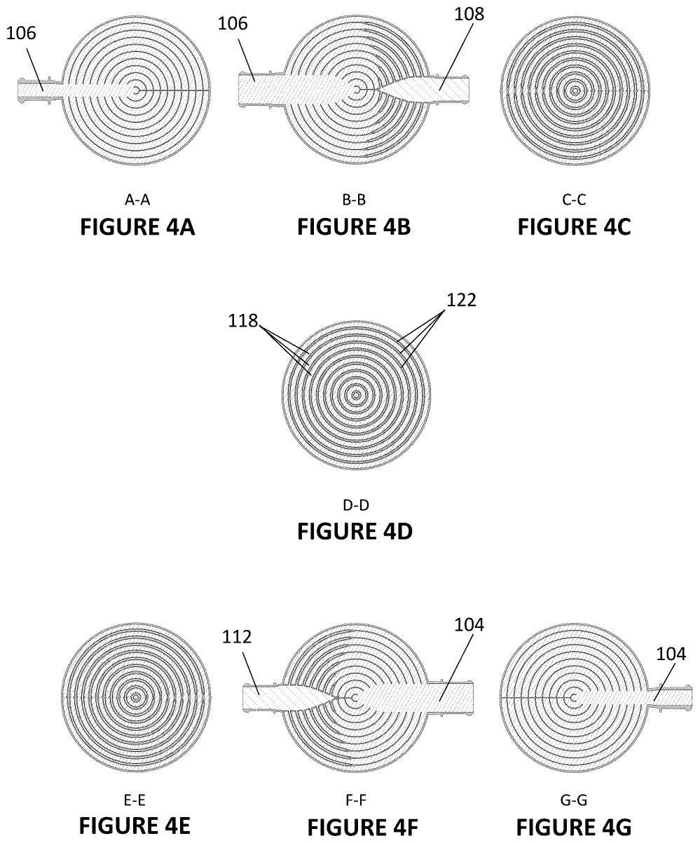

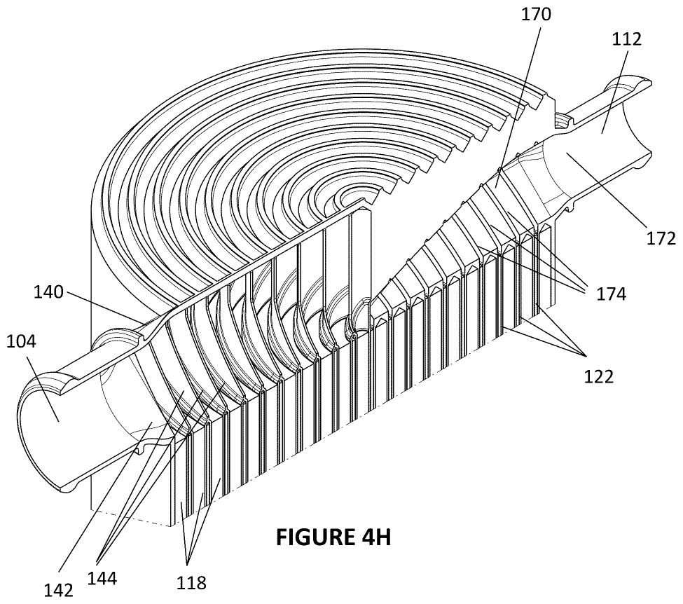

FIGS. 3A to 4G illustrate the heat exchanger 100 according to a second embodiment of the present invention. The outer shell 102 defines a first inlet port 104 diametrically opposite a second outlet port 112 and at the other end of the shell 102, a second inlet port 108 diametrically opposite a first outlet port 106.

Within the heat exchanger 100 is a core 114 comprising a plurality of concentric channels extending along a central axis 120. The plurality of channels are concentric about the central axis 120, and include a first set of concentric channels 118 and a second set of concentric channels 122.

In use, a first fluid enters the heat exchanger 100 via the first inlet port 104, passes through the core 114 via the first set of concentric channels 118 and exits the heat exchanger 100 via the first outlet port 106. A second fluid enters the heat exchanger 100 via the second inlet port 108, passes through the core 114 via the second set of concentric channels 122 and exits the heat exchanger 100 via the second outlet port 112. Each set of concentric channels 118, 122 comprises a plurality of channels. That is, the first set 118 preferably comprises more than two concentric channels for receiving the first fluid, and the second set 122 preferably comprises more than two concentric channels for receiving the second fluid.

The first fluid flows through the first inlet port 104 along a first axis 105 that is substantially orthogonal to the central axis 120, and through the first outlet port 106 along a second axis 107 that is also substantially orthogonal to the central axis 120. Similarly, the second fluid flows through the second inlet port 108 along a third axis 109 that is substantially orthogonal to the central axis 120, and through the second outlet port 112 along a fourth axis 113 that is also substantially orthogonal to the central axis 120.

Similar to the embodiment illustrated in FIGS. 1A-2K, as the first and second fluids flow through the heat exchanger 100, thermal energy is transferred between the two fluids. As shown more clearly in FIG. 3C, to facilitate and improve heat transfer, the concentric channels are alternatingly arranged, from the central axis, between a channel of the first set of concentric channels 118 and a channel of the second set of concentric channels 122.

Each channel is an elongate channel extending along the direction of the central axis 120. Each channel has a substantially annular cross-section, although in some regions, optional radially-extending fins (not shown) may intersect the channels.

The heat exchanger 100 comprises a first inlet manifold 140, contained within the outer shell 102, which is in fluid communication with the first inlet port 104 and the first set of concentric channels 118. Specifically, the first inlet manifold 140 connects the first inlet port 104 to the first set of concentric channels 118 and is configured to facilitate even flow distribution of the first fluid into each channel of the first set of concentric channels 118.

FIG. 4H is a close up view illustrating one example embodiment of the first inlet manifold 140. The first inlet manifold 140 comprises a first main channel 142 that spreads into a plurality of first branches 144 as the main channel 142 opens up into the first set of concentric channels 118. The first main channel 142 extends substantially parallel to the axis 105 and is in fluid connection with the first branches 144. Each of the first branches 144 is in fluid communication with a respective one of the channels of the first set of concentric channels 118.

In the example illustrated in FIGS. 3A to 4H, the inlet and outlet ends of the heat exchanger 100 are substantially identical. Accordingly, the heat exchanger 100 comprises a first outlet manifold 150, which is structurally substantially identical to the first inlet manifold 140, in that it comprises a first main channel 152, defined in the first outlet port 106, that spreads into a plurality of first branches 154, each branch being in fluid communication with one of the channels of the first set of concentric channels 118. In other examples, the first inlet manifold 140 may be different from the first outlet manifold 150.

Preferably, the first branches 144, 154 open up seamlessly into the first set of concentric channels 118, i.e. there are no seams at the connection between the walls of the first branches 144, 154 and the walls of the first set of concentric channels.

The heat exchanger 100 comprises a second inlet manifold 160 and a second outlet manifold 170, contained within the outer shell 102. Specifically, the second inlet manifold 160 connects the second inlet port 108 to the second set of concentric channels 122 and is configured to facilitate even flow distribution of the second fluid into each channel of the second set of concentric channels 122. The second inlet manifold 160 comprises a second main channel 162 that spreads into a plurality of second branches 164 as the second main channel 162 opens up into the second set of concentric channels 122. The second main channel 162 extends substantially parallel to the axis 109 and is in fluid connection with the second branches 164.

In one embodiment, the second inlet manifold 160 and the second outlet manifold 170 are structurally substantially identical. In other examples, the second inlet manifold 160 may be different from the second outlet manifold 170.

The second outlet manifold 170 connects the second set of concentric channels 122 with the second outlet port 112, and comprises a second main channel 172 that spreads into a plurality of second branches 174 as the second main channel 172 opens up into the second set of concentric channels 122. Each of the second branches 172 is in fluid communication with a respective one of the channels of the second set of concentric channels 122.

Preferably, the second branches 164, 174 open up seamlessly into the second set of concentric channels 122, i.e. there are no seams at the connection between the walls of the second branches 164, 174 and the walls of the second set of concentric channels.

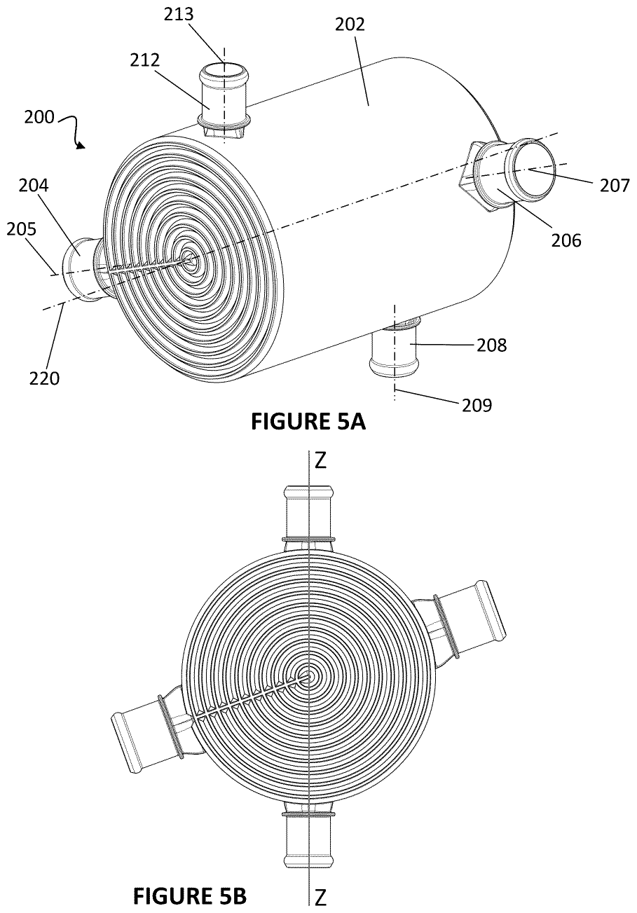

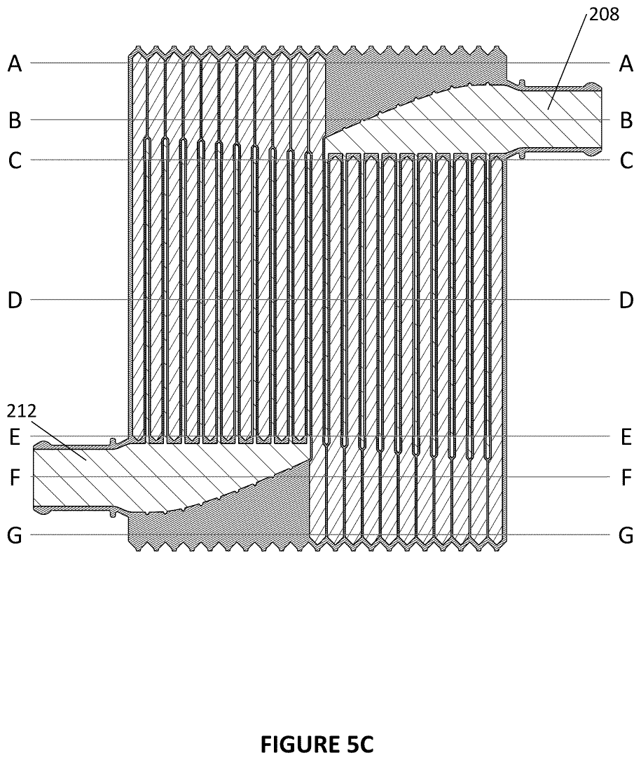

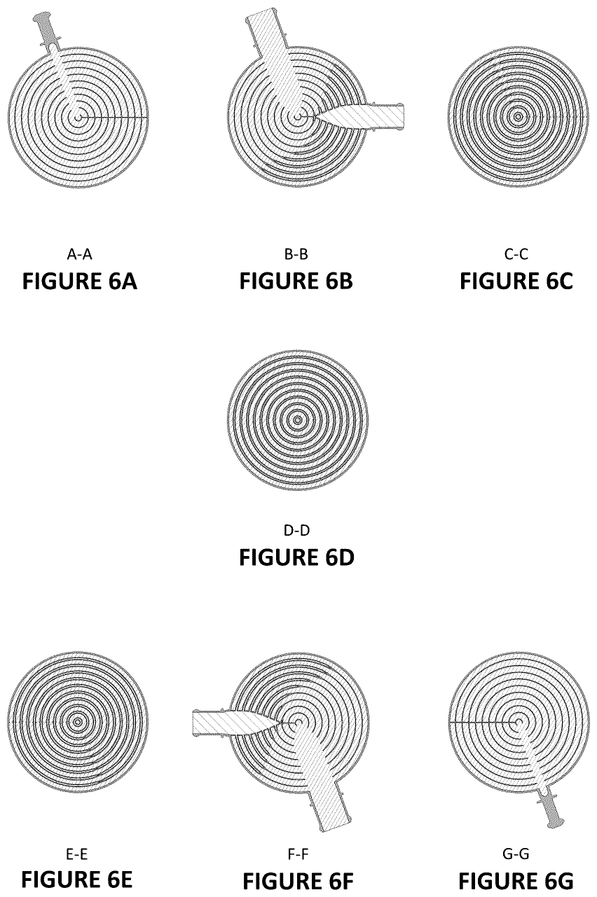

FIGS. 5A to 6G illustrate the heat exchanger 200 according to a third embodiment of the present invention. The heat exchanger 200 of this embodiment is similar to that of the second embodiment shown in FIGS. 3A to 4G, save for the position of the inlet 204, 208 and outlet ports 206, 212 and the respective axes along which fluid flows through the ports in use. Specifically, the first inlet port 204 is spaced about 110° from the second outlet port 112 at one end of the outer shell 202, and at the other end of the shell, a second inlet port 208 is spaced about 110° from the first outlet port 206. Flow through these ports 204, 206, 208 and 212 are along axes 205, 207, 209 and 213 respectively, all of which are substantially orthogonal to the central axis 220. In other examples, a different angular spacing between the inlet and outlet ports at each end of the heat exchanger may be provided.

In other examples, flow through at least one of the inlet ports and outlet ports may be parallel to the central axis 220 while flow through the remaining inlet and/or outlet ports may be substantially orthogonal to the central axis.

The arrangement of the internal walls of the manifold according to preferred embodiments has been found to condition the fluid such that a substantially smooth and even flow is delivered into the core. The walls of the branches additionally improve the structural integrity of the manifold and of the heat exchanger 10 in general.

In preferred embodiments, the heat exchanger 10, 100, 200 is formed via additive manufacturing, resulting in a jointless and seamless unitary/monolithic body. In particular, the walls of the inlet and outlet manifolds that define first and second manifold branches in fluid communication with respective concentric channels of the core are continuous with the channel walls defining those respective channels. The continuous connection between the manifold and the core ensures that fluid is conditioned by the manifold such that a smooth and even flow is delivered into the core. Further, the seamless monolithic construction prevents sealing and leakage issues that tend to plague conventional heat exchangers, due in large part to the fact that manifolds are conventionally mechanically fastened (e.g. welded) to the heat exchanger core, and tubes and/or channels within the core are conventionally mechanically bonded to an end plate.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

The claims defining the invention are as follows:

1. A heat exchanger comprising:
a core having a plurality of concentric channels extending along a central axis, the plurality of channels being concentric about the central axis and including:
a first set of concentric channels through which a first fluid can pass; and
a second set of concentric channels through which a second fluid can pass, to exchange heat with the first fluid passing through the first set of concentric channels,
the concentric channels being alternatingly arranged, from the central axis, between a channel of the first set of concentric channels and a channel of the second set of concentric channels.

2. The heat exchanger of claim 1, wherein each channel of the plurality of concentric channels is an elongate channel having a substantially annular cross-section.

3. The heat exchanger of claim 1 or 2, further including a first inlet port for transporting the first fluid into the core and a first outlet port for transporting the first fluid from the core, wherein one or each of the first inlet port and first outlet port defines a manifold comprising a main channel (“first main channel”) that opens up into the first set of concentric channels of the core.

4. The heat exchanger of claim 3, wherein the first main channel spreads into a plurality of branches, and wherein each branch opens up into a respective one of the concentric channels of the first set of concentric channels.

5. The heat exchanger of claim 4, wherein a spread of each branch from the first main channel increases around the central axis to form a substantially concentric channel as the first main channel approaches the first set of concentric channels of the core.

6. The heat exchanger of claim 4 or 5, wherein the manifold walls defining each of said branches are continuous and seamless with the walls defining the respective concentric channel of the first set of concentric channels to which the branch opens up.

7. The heat exchanger of any one of the preceding claims, further including a second inlet port for transporting the second fluid into the core and a second outlet port for transporting the second fluid from the core, wherein one or each of the second inlet port and second outlet port defines a manifold comprising a main channel (“second main channel”) that opens up into the second set of concentric channels of the core.

8. The heat exchanger of claim 7, wherein the second main channel spreads into a plurality of branches, and wherein each branch opens up into a respective one of the concentric channels of the second set of concentric channels.

9. The heat exchanger of claim 8, wherein a spread of each branch from the second main channel increases around the central axis to form a substantially concentric channel as the second main channel approaches the second set of concentric channels of the core.

10. The heat exchanger of claim 8 or 9, wherein the manifold walls defining each of said branches are continuous and seamless with the walls defining the respective concentric channel of the second set of concentric channels to which the branch opens up.

11. The heat exchanger of claim 3 or of any one of claims 4 to 10 where appended to claim 3, wherein fluid flow through one or each of the first inlet port and the first outlet port is along an axis that is substantially parallel to the central axis.

12. The heat exchanger of claim 3 or of any one of claims 4 to 10 where appended to claim 3, wherein fluid flow through one or each of the first inlet port and the first outlet port is along an axis that is substantially orthogonal to the central axis.

13. The heat exchanger of claim 7 or of any one of claims 8 to 12 where appended to claim 7, wherein fluid flow through one or each of the second inlet port and the second outlet port is along an axis that is substantially parallel to the central axis.

14. The heat exchanger of claim 7 or of any one of claim 8 to 12 where appended to claim 7, wherein fluid flow through one or each of the second inlet port and the second outlet port is along an axis that is substantially orthogonal to the central axis.

15. The heat exchanger of claim 4 or claim 8 or any one of claims 5 to 7 and 9 to 14 where appended to claim 4 or claim 8, further comprising one or more apertures in a manifold wall defining an outermost branch, wherein the or each aperture is configured to provide a fluid pathway through said wall.

16. The heat exchanger claim 4 or claim 8 or any one of claims 5 to 7 and 9 to 15 where appended to claim 4 or claim 8, further comprising fins spanning adjacent manifold walls defining a branch.

17. The heat exchanger of any one of the preceding claims, formed as a seamless unitary body via additive manufacturing.
